(19) United States
(12) Patent Application Publication
(10) Pub. No.: US 2023/0302545 A1
(43) Pub. Date: Sep. 28, 2023

(54) CUTTING TOOL ASSEMBLY WITH ADJUSTABLE DAMPERS

(71) Applicant: Kennametal India Limited, Latrobe, PA (US)

(72) Inventors: YOGESH BASAVARAJU, Bangalore (IN); IRANNA SHIDRAMESHETRA, Bangalore (IN)

(21) Appl. No.: 18/124,896

(22) Filed: Mar. 22, 2023

(30) Foreign Application Priority Data
Mar. 23, 2022 (IN) 202241016279

(51) Int. Cl. B23B 29/02

(52) U.S. Cl. CPC B23B 29/022; B23B 2228/56; B23B 2222/04; B23B 2222/21; B23B 2222/98; B23B 2222/84; B23B 2222/44; B23B 2265/36; B23B 2265/12

(57) ABSTRACT

A boring bar has a generally cylindrical elongate tool body has a proximal end for mounting to drive unit and a distal end for attachment to a tool head. A passageway extends longitudinally along the central axis of the elongate tool body. A plurality of longitudinally extending cavities are disposed annularly about the tool body. A compressive material is disposed in each of the cavities. An adjustable compression fitting is disposed in at least one end of each of the cavities, where each of the compression fitting can be adjusted to change compression of the material disposed in a respective cavity.

### BACKGROUND

This relates in general to cutting tools for metal working

During a metalworking operation with a rotary or stationary cutting tool, there is a tendence for vibrations to be caused by the relative motion between a workpiece and a cutting tool being acting on the workpiece. This may be magnified by fluctuations in the applied cutting force and may lead to an unstable condition known as chatter. Chatter is an example of self-excited vibration. As a result of this vibration, undesired effects may occur, such as unintended surface finish(es) and/or the results being an out-of-tolerance for the finished workpiece produced.

Chatter may be especially problematic when the cutting tool is coupled to a boring bar. A boring bar is essentially a generally cylindrical elongate body, which is anchored at one end, typically to a drive unit, and attached to the cutting tool at the other end. Boring bars are conventionally formed from a metal alloy, such as, carbon steel. In one operation, to reduce vibrations of the boring bars, cutting parameters such speed and depth of cut may be reduced, decreasing the metal removal rate.

Several methods to attempt to reduce boring bar vibration are known. One method for attempting to reduce vibration includes using a boring bar fabricated from a relatively stiffer material than standard carbon steel, such as solid carbide (e.g., tungsten carbide). Another method to attempt to reduce vibration in boring bars includes using a vibration absorber mechanism, such as placement of a cylindrical mass of a high-density material, relative to the boring bar, within the boring bar.

### SUMMARY

This relates more particularly to a tunable boring bar for suppressing vibrations caused in machining processes.

In one embodiment, a tool for a cutting tool operation includes a generally cylindrical elongate tool body having a proximal end for mounting to drive unit and a distal end for attachment to a tool head. A passageway extends longitudinally along the central axis of the elongate tool body. A plurality of longitudinally extending cavities are disposed annularly about the tool body. A compressive material is disposed in each of the cavities. An adjustable compression fitting is disposed in at least one end of each of the cavities. The compression fitting can be adjusted to change compression of the material disposed in a respective cavity.

A tool head, adapted to receive a cutting element, attached to the distal end of the tool body and includes a passageway in communication with the passageway of the tool body for the delivery of fluid to a work piece. A cutting element is disposed on the tool head.

In at least one embodiment, the adjustable compression fittings are disposed at the proximal ends of each of the cavities.

In at least one embodiment, a generally cylindrical insert is disposed within the passageway of the tool body and extends longitudinally along the central axis of the elongate tool body. The insert preferably has a higher density than the tool body. For example, the tool body may be made of a carbon steel and the insert may be made of a carbide material.

In at least one embodiment, the cavities extend from the proximal end, and the cavities each have an adjustable compression fitting disposed in the proximal end of each of the cavities.

In at least one embodiment a boring bar includes a generally cylindrical elongate tool body having a proximal end for mounting to drive unit and a distal end for attachment to a tool head. A passageway extends longitudinally along the central axis of the elongate tool body. A plurality of longitudinally extending cavities are disposed annularly about the tool body. A compressive material is disposed in each of the cavities. An adjustable compression fitting is disposed in at least one end of each of the cavities. Each of the compression fittings can be adjusted to change compression of the material disposed in a respective cavity.

The adjustable compression fitting may be a screw mechanism.

The cavities may be disposed about equal angular spacing of the tool body. Additionally, or alternatively, the cavities may be disposed at equal radial distance from the central axis of the tool body. The cavities may be disposed in a circular pattern or pattern of concentric circles. Further, the cavities may be disposed in an offset pattern of varying angular spacing and/or radial distance where the cavities are otherwise geometrically balanced about the central axis of the tool body. In a number of embodiments, the cavities may extend from the proximal end to the distal end. In certain embodiments, the cavities have adjustable compression fittings disposed in both the proximal ends and the distal ends of each of the cavities.

The compressive material may include particles of differing sizes. For example, the compressive material may include particles that range in the size of 0.20 to 6.0 microns. The compressive material may be limited to particles that range in the size of 0.20 to 0.75 microns, and/or particles that range in the size of 1.3 to 6.0 microns. In one embodiment, the compressive material includes particles that are a mixture of particles that that range in the size of 0.20 to 0.75 microns, and particles that range in the size of 1.3 to 6.0 microns. In a number of embodiments, the compressive material is a multi-phase material including the particles of differing sizes in solid state and including a liquid, with the particles and the liquid form a slurry.

The compressive material may include particles of differing shapes. For example, the differing shapes may include at least two of spherical, droplet, diamond, and pyramidal.

The compressive material may include particles of differing surface finish.

The compressive material may include particles of differing substances. For example, differing substances may include at least two of aluminum, copper, zinc, iron, steel, and carbide, or other heavy metal.

Various aspects will become apparent to those skilled in the art from the following detailed description and the accompanying drawings.

### BRIEF DESCRIPTION OF THE DRAWINGS

FIG. 1 is a top side perspective view of a tool assembly with adjustable dampers.

FIG. 2 is a top view of the tool assembly of FIG. 1.

FIG. 3 is a partial side schematic view of the tool assembly holder of FIG. 1.

FIG. 4 is a side cross-sectional view of the tool assembly of FIG. 1 taken along line 4-4 in FIG. 3.

### DETAILED DESCRIPTION

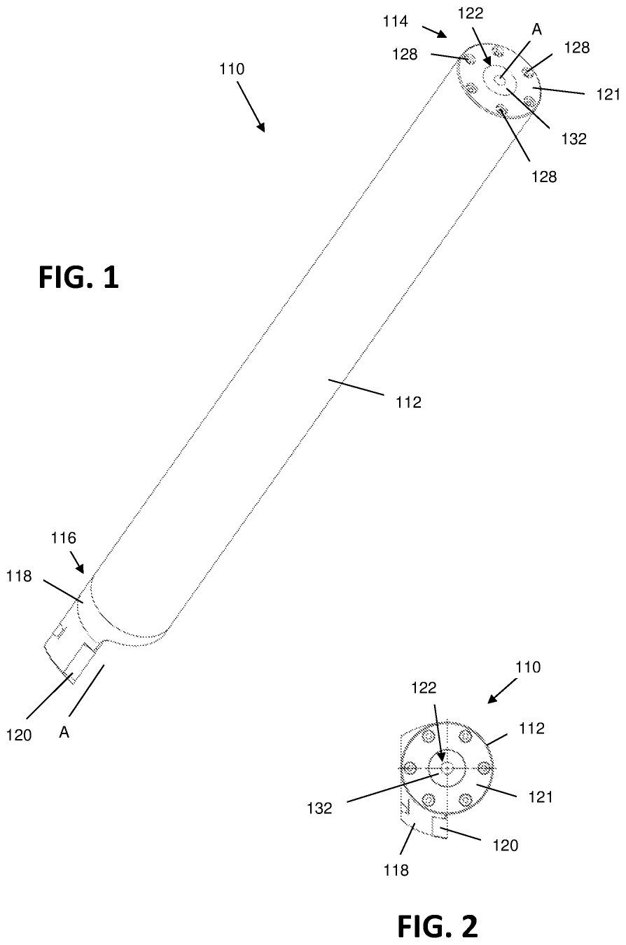

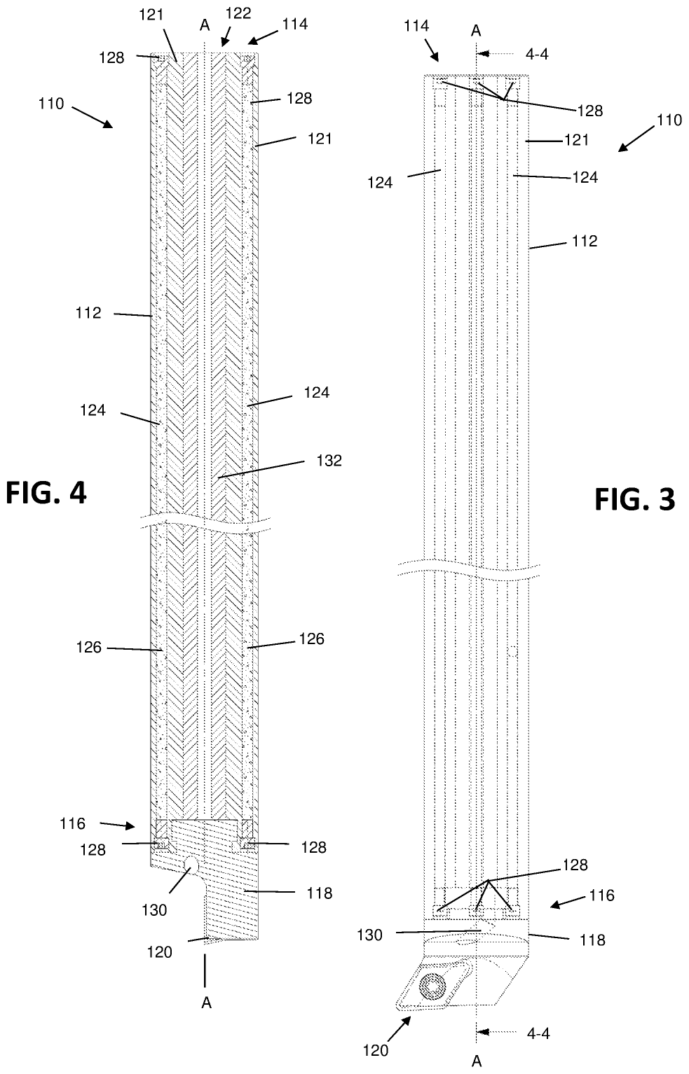

Referring now to the drawings, there is illustrated in FIGS. 1-4, a tool assembly 110 for a cutting tool operation includes a generally cylindrical elongate tool body 112, i.e. a boring bar, having a proximal end 114 for connection to a drive unit and a distal end 116 for connection to a tool head or tool insert holder 118. A cutting element or tool insert 120 is disposed on the tool head 118.

The generally cylindrical elongate tool body 112 includes an outer main body 121 having a passageway 122 extending longitudinally along the central axis A of the elongate tool body 112 from the proximal end 114 to the distal end 116.

The tool head 118, adapted to receive the cutting element 120 and attached to the distal end 116 of the tool body 112, includes a passageway 130 in communication with the passageway 122 of the tool body 112 for the delivery of fluid to a work piece.

A plurality of longitudinally extending cavities 124 are disposed annularly about the tool body 112. A compressive material 126 is disposed in each of the cavities 124. An adjustable compression fitting 128 is disposed in at least one end of each of the cavities 124. Each of the compression fittings 128 can be adjusted to change compression of the material 126 disposed in a respective cavity 124.

In at least one embodiment, the cavities 124 extend from the proximal end 114 and extend into the tool body 112 and may extend to the distal end 116. In this example, each cavity 124 preferably has an adjustable compression fitting 128 disposed in the proximal end of each of the cavities 124, as to be accessible even when the tool head 118 is connected to the tool body 112. Although, each cavity may have an adjustable compression fitting 128 at either or both ends.

In at least one embodiment, the adjustable compression fitting 128 is a screw mechanism that may interact with threads disposed in the tool body 112 or cooperate with threads in a threaded insert placed in the cavity 124. In at least one other embodiment, the adjustable compression fitting 128 is a fluid driven element that may be hydraulically or pneumatically controlled.

The cavities 124 may be disposed about equal angular spacing of the tool body. Additionally, or alternatively, the cavities 124 may be disposed at equal radial distance from the central axis A of the tool body 112.

The compressive material 126 may include particles of differing sizes. For example, the compressive material 126 may include particles that range in the size of 0.20 to 0.75 microns, and/or particles that range in the size of 1.3 to 6.0 microns. In a number of embodiments, the compressive material 126 is a multi-phase material including the particles of differing sizes in solid state and including a liquid, with the particles and the liquid form a slurry.

Further, the compressive material 126 may include particles of differing shapes. For example, the differing shapes may include at least two of spherical, droplet, diamond, and pyramidal.

Additionally, the compressive material 126 may include particles of differing surface finish.

The compressive material 126 may include particles of differing substances. For example, the differing substances may include at least two of aluminum, copper, zinc, iron, steel, and carbide, or other heavy metal.

In one operation, the compressive material 126 can be tuned, i.e. subject to increased or decreased compression, by adjusting the adjustable compression fittings 128. It is expected that such will adjust the density of particles of the compressive material 126, which will modify the static and or dynamic stiffness of the boring bar 112, and reduce the chatter in a milling operation. It is further expected that such operation will change the radial pressure created by the compressive material 126 in the cavities 124. Thus, the stiffness of the boring bar 112 can be varied by adjusting the compression and/or compacting of the compressive material 126 with the adjustable compression fittings 128. It must be understood that density of the compressive material 126 prior to any action by the compression fittings 128 may be a relatively low-density or high-density material as desired for a particular tool assembly 110.

As illustrated, an optional generally cylindrical insert 132 is disposed within the passageway 122 of the tool body 112 and extends longitudinally along the central axis A of the elongate tool body 112. The insert 132 preferably has a higher density than the tool body 112. For example, the tool body 112 may be made of a carbon steel and the insert 132 may be made of a carbide material. It is expected that inclusion of the insert 132 will improve the stiffness of the overall tool assembly 110, as compared to an assembly with out the insert 132.

In one embodiment, the boring bar 112 is a higher L/D ratio boring bar, e.g. a L/D ration of 4 or more, and preferably in the range of 4 to 10. In one particular embodiment, the boring bar 112 has a length of at least 20 mm.

While principles and modes of operation have been explained and illustrated with regard to particular embodiments, it must be understood, however, that this may be practiced otherwise than as specifically explained and illustrated without departing from its spirit or scope.

What is claimed is:

1. A boring bar comprising:
a generally cylindrical elongate tool body having a proximal end for mounting to drive unit and a distal end for attachment to a tool head, with a passageway extending longitudinally along the central axis of the elongate tool body, and a having a plurality of longitudinally extending cavities disposed annularly about the tool body;
a compressive material disposed in each of the cavities; and
an adjustable compression fitting disposed in at least one end of each of the cavities, where each of the compression fitting can be adjusted to change compression of the material disposed in a respective cavity.

2. The boring bar of claim 1 where the adjustable compression fitting is a screw mechanism.

3. The boring bar of claim 1 where the adjustable compression fitting is a fluid driven element that is one of hydraulically and pneumatically controlled.

4. The boring bar of claim 1 where the cavities are disposed about equal angular spacing of the tool body.

5. The boring bar of claim 1 where the cavities are disposed at equal radial distance from the central axis of the tool body.

6. The boring bar of claim 1 where the cavities extend from the proximal end to the distal end.

7. The boring bar of claim 6 where the cavities have adjustable compression fittings disposed in both the proximal ends and the distal ends of each of the cavities.

8. The boring bar of claim 1 where the compressive material includes particles of differing sizes, where the size of the particles ranges in the size of 0.20 to 6.0 microns.

9. The boring bar of claim 8 where the compressive material is limited to particles that range in the size of 0.20 to 0.75 microns.

10. The boring bar of claim 8 where the compressive material is limited to particles that range in the size of 1.3 to 6.0 microns.

11. The boring bar of claim 8 where the compressive material is a multi-phase material including the particles of differing sizes in solid state and including a liquid, where the particles and the liquid form a slurry.

12. The boring bar of claim 1 where the compressive material includes particles of differing shapes.

13. The boring bar of claim 12 where the differing shapes include at least one of spherical, droplet, diamond, and pyramidal.

14. The boring bar of claim 1 where the compressive material includes particles of differing surface finish.

15. The boring bar of claim 1 where the compressive material includes particles of differing substances.

16. The boring bar of claim 15 where the differing substances include at least one of aluminum, copper, zinc, iron, steel, and carbide.

17. A tool for cutting tool operation comprising:
a generally cylindrical elongate tool body having a proximal end for mounting to drive unit and a distal end for attachment to a tool head, with a passageway extending longitudinally along the central axis of the elongate tool body, and a having a plurality of longitudinally extending cavities disposed annularly about the tool body;
a compressive material disposed in each of the cavities; and
an adjustable compression fitting disposed in at least one end of each of the cavities, where each of the compression fitting can be adjusted to change compression of the material disposed in a respective cavity.
a tool head adapted to receive a cutting element attached to distal end of the tool body and including a passageway in communication with the passageway of the tool body for the delivery of fluid to a work piece, and
a cutting element disposed on the tool head.

18. The tool of claim 17 where the adjustable compression fittings are disposed at the proximal ends of each of the cavities.

19. The tool of claim 17 further comprising a generally cylindrical insert disposed within the passageway of the tool body and extending longitudinally along the central axis of the elongate tool body, where insert has a higher density than the tool body.

20. The tool of claim 16 where the cavities extend from the proximal end, and where the cavities each have an adjustable compression fitting disposed in the proximal end of each of the cavities.
